(19) United States
(12) Patent Application Publication
(10) Pub. No.: US 2024/0375952 A1
(43) Pub. Date: Nov. 14, 2024

(54) Microwave Cracking of Hydrocarbons

(71) Applicant: CHA CORPORATION, Sacramento, CA (US)

(72) Inventors: Suk Bae Cha, Tokyo (JP); Chang Yul Cha, Sacramento, CA (US)

(21) Appl. No.: 18/289,816

(22) PCT Filed: May 9, 2022
(86) PCT No.: PCT/GB2022/051174

§ 371 Date: Nov. 7, 2023

(30) Foreign Application Priority Data
May 7, 2021 (GB) 2106556.0

(51) Int. Cl. C01B 3/30; C01B 32/05

(52) U.S. Cl. CPC C01B 3/30; C01B 32/05; C01B 2203/049; C01B 2203/1047; C01B 2203/1235; C01B 2203/1614

(57) ABSTRACT

A process of forming hydrogen and a carbon product, for example carbon black. A hydrocarbon-containing input gas, for example methane, is passed through a reaction bed in a microwave reaction chamber irradiated with microwave radiation. The reaction bed comprises a particulate material comprising at least one of a metal or metal compound and a carbon material.

### BACKGROUND

There is an urgent need to reduce combustion of hydrocarbon fuels such as methane and replace these fuels with alternative energy sources. One such alternative energy source is hydrogen which may be used in, for example, an internal combustion engine or a fuel cell.

Another alternative energy source is lithium-ion batteries, which commonly contain conductive carbon such as carbon black in the battery anode.

Production of hydrogen from hydrocarbons using microwave energy is known, for example as disclosed in U.S. Pat. No. 5,164,054.

WO 2021/014111 discloses a process for producing hydrogen in which a gaseous hydrocarbon is exposed to microwave radiation in the presence of a catalyst of an iron species supported on a ceramic or carbon support.

US 2008/0210908 discloses a method for producing hydrogen-enriched fuel and carbon nanotubes.

R Ebner S Ellis S Golunski, “Deactivation and durability of the catalyst for Hotspot natural gas processing”, ETSU F/02/00173/REP identifies presence of sulphur compounds and build up of carbon deposits among potential causes of deactivation of a natural-gas reforming catalyst.

It is an object of the invention to provide an energy-efficient process for cracking of hydrocarbons, in particular methane, to hydrogen and a carbon product, in particular carbon black.

It is a further object of the invention to provide a low-cost method for cracking of hydrocarbons, in particular methane, to hydrogen and a carbon product.

It is a yet further object of the invention to provide a method for cracking of hydrocarbons, in particular methane, to hydrogen and a carbon product which produces less CO and/or CO₂ than steam-methane reforming.

It is a yet further object of the invention to provide a method of controlling the size of carbon particles formed in cracking of hydrocarbons.

### SUMMARY

In a first aspect, the invention provides a process of forming hydrogen and a carbon product comprising passing a hydrocarbon-containing input gas through a reaction bed in a microwave reaction chamber and irradiating the microwave reaction chamber with microwave radiation wherein the reaction bed comprises a particulate material comprising at least one of a metal or metal compound and a carbon material.

Preferably, the reaction bed comprises the particulate metal or metal compound.

Optionally, the reaction bed is a moving reaction bed.

Optionally, the reaction bed further comprises a microwave-absorbing compound.

In a second aspect, the invention provides a process of forming hydrogen and a carbon product comprising bringing a hydrocarbon-containing input gas into contact with a combination of microwave-absorbing material and a metal or metal compound in a microwave reaction chamber and irradiating the microwave reaction chamber with microwave radiation.

Optionally according to the second aspect, the hydrocarbon-containing input gas is passed through a reaction bed comprising the microwave-absorbing material and the metal or metal compound.

Optionally according to the first or second aspect the carbon product is carbon black.

Optionally, additional carbon is added to the reaction chamber, optionally while the microwave reaction in the reaction chamber is ongoing. Optionally, the carbon added to the reaction chamber is additional carbon black.

Optionally, a portion of solid product which has been removed from the microwave reaction chamber, e.g. solid product containing or consisting of carbon black, is recycled back to the reaction chamber.

Optionally according to the first or second aspect the product carbon is not separated from the reaction bed in the microwave reaction chamber.

Optionally according to the first or second aspect the residency of the carbon black product in the reactor while the reaction is ongoing is selected according to a desired carbon black product mean diameter.

Optionally according to the first or second aspect the carbon product has a mean average diameter of at least 1 nm, optionally at least 8 nm, optionally at least 15 nm.

Optionally according to the first or second aspect the metal or metal compound is present and is consumed during the process.

Optionally according to the first or second aspect additional metal or metal compound is added to the reaction chamber, optionally while the microwave reaction in the reaction chamber is ongoing.

It will be understood that “additional carbon” and “additional metal or metal compound” as used herein are additional to carbon and metal or metal compound present at a starting point of a process as described herein.

Optionally according to the first or second aspect the metal or metal compound is a transition metal or transition metal compound.

Optionally according to the first or second aspect the metal or metal compound is iron oxide.

Optionally according to the first or second aspect the hydrocarbon-containing gas contains methane.

Optionally according to the first or second aspect at least 50 mol %, optionally at least 70 mol %, of the hydrocarbon in the input gas is converted to hydrogen gas in a single pass reaction. Optionally, the conversion of at least 50 mol % or at least 70 mol % is maintained for a continuous period of at least 1 hour.

Optionally according to the first or second aspect the metal or metal compound is a metal oxide and wherein carbon monoxide and carbon dioxide in a product gas produced in a single pass process collectively make up between 0.1-10 vol % of the product gas.

Optionally according to the first or second aspect the input gas comprises a sulfur-containing compound.

Optionally according to the first or second aspect gas temperature in the microwave reaction chamber is below 1000° C., optionally in the range of 200-900° C.

Optionally according to the first or second aspect the input gas is free from water.

In a third aspect the invention provides apparatus for conversion of a hydrocarbon to hydrogen and carbon black comprising:
a microwave radiation source; and
a microwave reaction chamber having a gas inlet for introduction of an input gas comprising a hydrocarbon; a gas outlet for removal of a product gas from the microwave reaction chamber; a solid inlet for introduction of solid material into the microwave reaction chamber; and a solid outlet for removal of solid product from the reaction chamber.

Optionally according to the third aspect the microwave reaction chamber comprises a gas conduit between the gas inlet and gas outlet which is configured to move solid material within the conduit towards the solid outlet.

Optionally, the conduit is at an angle of at least 20° to the vertical, optionally at least 40°, 60° to the vertical, optionally within 10° of horizontal. It will be understood that the angle of the conduit as described herein is the angle when the apparatus is in use or positioned and oriented ready for use.

Optionally according to the third aspect the apparatus further comprises a gas recycle path for recycling unreacted hydrocarbon exiting the microwave reaction chamber back into the microwave reaction chamber.

Optionally according to the third aspect the apparatus comprises a pre-heater for heating gas prior to entry into the microwave reaction chamber; a carbon monoxide separator for separating carbon monoxide from gas exiting the microwave reaction chamber and a carbon monoxide flow path for delivering separated carbon monoxide to a fuel source for the pre-heater.

Optionally according to the third aspect the apparatus comprises a carbon product recycle path for recycling a portion of the solid product into the microwave reaction chamber.

A process according to the first or second aspect may be carried out with the apparatus according to this third aspect.

In use, the metal or metal compound and optionally one or more further materials, e.g. one or more microwave-absorbing materials, may be introduced into the solid inlet. The one or more further materials may be supplied separately from the metal or metal compound or as a mixture with the metal or metal compound.

In use, the solid product removed from the reaction chamber may include the carbon product and the metal or metal compound (in the case where the metal or metal compound is catalytic) or a product formed by reaction of the metal or metal compound (in the case where the metal or metal compound is consumed during the reaction).

In a fourth aspect the invention provides use of carbon black as a nucleating agent in microwave-assisted conversion of a hydrocarbon into carbon black and hydrogen.

In a fifth aspect the invention provides a composition comprising a particulate metal or metal compound and a particulate microwave-absorbing material which is different from the metal or metal compound.

Optionally according to the fifth aspect, the metal or metal compound is an iron compound, optionally iron oxide.

Optionally according to the fifth aspect, the particulate microwave absorbing material comprises or consists of at least one of carbon and silicon carbide.

### DESCRIPTION OF THE DRAWINGS

The invention will now be described in more detail with reference to the Figures in which:

FIG. 1, which is not drawn to any scale, illustrates a microwave reaction chamber according to some embodiments;

FIG. 2, which is not drawn to any scale, illustrates apparatus containing a microwave reaction chamber according to some embodiments;

FIG. 3, which is not drawn to any scale, illustrates apparatus containing a microwave reaction chamber having an angled moving bed according to some embodiments;

FIG. 4 is a graph of CH₄ conversion vs. time using MgO-impregnated granular activated carbons in a fixed bed;

FIG. 5 is a graph of CH₄ conversion vs. time using a petroleum coke in a fixed bed;

FIG. 6 is a graph of CH₄ conversion vs. time using Fe₂O₃ between SiC layers;

FIG. 7 is a graph of CO and CO₂ concentration in an output gas on a first day of the reaction of FIG. 6;

FIG. 8 is a graph of CO and CO₂ concentration in an output gas on a second day of the reaction of FIG. 6;

FIG. 9 is a graph of CH₄ conversion vs. CH₄ flow rate using Fe₂O₃ impregnated alumina and SiC layers;

FIG. 10 is a graph of CH₄ conversion vs. gas temperature using Fe₂O₃ impregnated alumina and SiC layers;

FIG. 11 is a graph of CH₄ conversion vs. time using Fe₂O₃ impregnated alumina and SiC layers;

FIG. 12 is a graph of a fraction of carbon black converted to CO for the reaction of FIG. 11;

FIG. 13 is a photograph of agglomerated carbon black produced in the reaction of FIG. 11;

FIG. 14 is a graph of natural gas conversion vs. time using the product of the reaction of FIG. 11;

FIG. 15 is a graph of H₂, CH₄, CO and CO₂ concentrations of an output gas of the process of FIG. 14;

FIG. 16 is a graph of CH₄ conversion vs. time using silicon carbide coating with iron oxide powder;

FIG. 17 is a graph of CO and CO₂ concentrations of an output gas of the process of FIG. 16;

FIG. 18 is a graph of percentage of carbon reacted with Fe₂O₃ vs time for the process of FIG. 16;

FIG. 19 is a graph of natural gas conversion vs. time for a carbon black product produced by methane cracking mixed with iron powder;

FIG. 20 is a graph of CO and CO₂ concentrations of an output gas of the process of FIG. 19;

FIG. 21 is a graph of percentage of carbon reacted with Fe₂O₃ vs time for the process of FIG. 19;

FIG. 22 is a graph of H₂S destruction efficiency vs microwave power in a reactor filed with a granular activated carbon;

FIG. 23 is a graph of CH₄ conversion vs. time in a fluidised bed containing petroleum coke;

FIG. 24 is a graph of H₂ concentration in an output gas vs time for the process of FIG. 23; and

FIG. 25 is a graph of is a graph of CH₄ conversion vs. time in a fluidised bed reaction with 0.5-1.3 mm petroleum coke.

### DETAILED DESCRIPTION

Hydrocarbon cracking as described herein includes introduction of a hydrocarbon-containing gas into a microwave reactor containing at least one of carbon and a metal or metal compound. In the case where the microwave reactor contains the metal or metal compound, the microwave reactor preferably further comprises a microwave-absorbing material.

It will be understood that the carbon or metal or metal compound may have some microwave absorbing capacity and that the “microwave absorbing material” as described herein is different from the metal or metal compound. The microwave absorbing material may have a greater microwave-absorbing capacity per unit mass than the metal or metal compound.

In the case where the microwave reactor contains the metal or metal compound, the microwave absorbing material may be a microwave-absorbing carbon material or another microwave-absorbing carbon material.

The reaction may be conducted at a gas temperature below a plasma temperature, e.g. below 900° C. Without wishing to be bound by any theory, the microwave-absorbing material may allow the reaction to take place in a reaction bed containing the microwave-absorbing material and the metal or metal compound, removing the need for a gas-phase reaction in a plasma. Reaction within the bulk of a reaction bed may be enhanced by passing the hydrocarbon-containing gas through (rather than over the surface of) the reaction bed.

It will be understood that the reaction bed as described herein consists of carbon and/or the metal or metal compound, or comprises the carbon and/or the metal or metal compound and one or more further particulate materials, optionally one or more further microwave-absorbing materials.

A microwave-absorbing material as described herein may be any solid material which increases rapidly in temperature upon exposure to microwave radiation, and which does not react with the input gas (catalytically or otherwise) to form hydrogen. Suitable materials are solid conductors or semiconductors, including metallic and non-metallic conductors. Exemplary microwave-absorbing compounds include, without limitation, carbon materials, e.g. carbon black or activated carbon, and silicon carbide and combinations thereof. A mixture comprising one or more of the metal or metal compound and one or more microwave-absorbing compounds may contain the metal or metal compound as a minor component (less than 50% by weight).

Preferably, the carbon product is carbon black.

The present inventors have surprisingly found that inclusion of carbon black in the process as described herein can result in formation of larger carbon black product particles as compared to a process in which carbon black is not provided. Without wishing to be bound by any theory, the presence of carbon black may provide a nucleation point for growth of carbon black particles during the reaction. Optionally, carbon black is the only microwave-absorbing compound in the reaction bed.

The presence of these nucleation points may limit formation of fine carbon black particles. Fine carbon black particles may coat the metal or metal compound, thereby reducing its ability to crack the hydrocarbon. Furthermore, it may be difficult to isolate fine carbon black particles which can become entrained in the gas flowing through the reaction apparatus and coat the internal walls of the apparatus.

The dimensions and/or physical characteristics of carbon black product particles may be controlled by controlling the residency time of carbon black in a reactor during a reaction and/or recycling product carbon black into the reactor. For example, in a moving bed arrangement the time taken for carbon black to pass through the reactor may be selected according to the desired dimensions and/or physical characteristics of the carbon black product.

Optionally, the mean average diameter of carbon black product particles is 1 nm or higher, optionally 10 nm or higher, optionally 15 nm or higher, optionally in the range of 1 nm-1 micron. The mean average diameter may be measured by methods known to the skilled person, for example using a Particle Size Analyzer (UPA-EX150, Nikkiso, Japan).

The physical characteristics include morphology and/or jetness of the carbon black.

The metal or metal compound may be selected from metals; metal compounds such as oxides and derivatives thereof, and alloys or mixtures thereof. The metal or metal compound may be, without limitation, an alkali metal, an alkali earth metal, a transition metal or an oxide thereof.

Exemplary metals or oxides thereof include, without limitation, iron, nickel, copper, magnesium, and potassium.

Iron oxide is particularly preferred.

In some embodiments, the metal or metal compound is provided in neat form. In some embodiments, the metal or metal compound is supported on a carrier, e.g. a ceramic such as alumina.

In the case where the metal or metal compound is a metal, e.g. iron, the metal may function as a catalyst.

In the case where a metal compound is present, e.g. a metal oxide, the metal compound may be consumed during the reaction, i.e. the metal compound is non-catalytic. In the case where a non-catalytic metal oxide is present, carbon monoxide and/or carbon dioxide may be present in the product gas. Optionally, carbon monoxide and carbon dioxide collectively make up between 0.1-10 vol % of the product gas produced in a single pass process. By “single pass process” as used anywhere herein is meant a process in which an output gas is not recycled back into the microwave reaction chamber.

Regardless of whether the metal or metal compound is catalytic, it will be understood that it initiates the reaction for conversion of the hydrocarbon product to hydrogen and a carbon product.

The metal or metal compound, or material comprising the metal or metal compound, may be provided in particulate form. The metal or metal compound particle size may be selected to be larger or smaller than the size of carbon product formed by the process described herein such that the metal or metal compound and carbon product may be separated by a screening process. Additionally or alternatively, a difference in densities of these materials may be used to separate them.

The present inventors have found that cracking of hydrocarbons may be achieved using a Fe—C compound formed upon microwave irradiation of Fe₂O₃ and carbon, e.g. carbon black. Accordingly, in a preferred embodiment, the metal compound is a microwave reaction product of Fe₂O₃ and carbon.

At the start of the reaction, the metal or metal compound and the microwave-absorbing material may be provided in a reactor as a mixture, as separate layers or as a combination thereof. In some embodiments, the metal or metal compound may be the only solid material in the reactor. In some embodiments, the metal or metal compound and the microwave-absorbing material may be the only two materials in the reactor. In some embodiments, one or more further materials may be present, e.g. one or more further microwave-absorbing materials.

The reaction may be a batch or continuous process. A supply of the carbon, metal or metal compound and, optionally, one or more microwave-absorbing materials, may be continuously or continually replenished. By “continually replenished” as used herein means intermittent replenishment.

The rate at which the metal or metal compound or microwave absorbing materials are replenished may be determined by the rate and which reactants pass through the reaction and product is separated and optionally recycled back through the reactor.

In the process described herein, the hydrocarbon-containing gas preferably passes through a bed comprising the metal or metal compound and the microwave-absorbing material. The present inventors have surprisingly found that the presence of the carbon product, e.g. carbon black generated in this cracking process may increase yield of hydrogen. Without wishing to be bound by any theory, cracking within the bulk of the reaction bed may limit an effect of carbon product coating the metal or metal compound as compared to a reaction at a surface of a layer containing the metal or metal compound. Furthermore, a metal-carbon compound formed from the metal or metal compound and the carbon product may help maintain a high conversion rate of the hydrocarbon.

Therefore, in some embodiments, at least some carbon product formed in the reactor is retained within the reactor for subsequent cracking reactions, and/or a portion of carbon product produced by a reactor is recycled back into the reactor.

Additionally, absorption of microwave energy generated by the carbon product may prevent formation of localised hot spots within the reactor or may react with an iron compound such as Fe₂O₃ to form a Fe—C compound suitable for cracking of hydrocarbons.

Carbon product may, additionally or alternatively to being entrained within gas flow, accumulate at the surface of a reaction bed. Removal of a part of the reaction bed may comprise removal of carbon product formed at a surface of the reaction bed; in which case the removed material may consist essentially (e.g. may be at least 95% by weight) of carbon product.

Removal of a part of the reaction bed may comprise removal of carbon product and spent metal or metal compound.

The ratio of metal or metal compound to carbon product within the reactor may be controlled by one or more of removing some of the reaction bed, e.g. a part of the reaction bed that is rich in carbon product, such as from a moving bed reactor; adding fresh metal or metal compound to the reactor; and adding recycled carbon product to the reactor.

Optionally, the metal or metal compound: microwave-absorbing material weight ratio is in the range of about 1:99-99:1, preferably 1:99-10:90.

A homogenous mixture of the metal or metal compound and carbon product may be maintained by any method known to the skilled person, e.g. mechanical agitation of mixture and/or passing a fluid through the reaction bed.

The input gas suitably contains at least 10% by volume of hydrocarbons, more preferably at least 20% by volume of hydrocarbons.

The input gas suitably contains at least 10% by volume of methane, optionally at least 20% by volume of methane.

Hydrocarbons as described herein are preferably selected from C₁₋₄ alkanes and C₁₋₄ alkenes.

Preferably, the input gas contains less than 10% by volume of water, preferably less than 1% by volume of water. Optionally, the input gas is free from water.

By “input gas” as used herein is meant a gas entering a microwave reaction chamber.

Input gas may be heated by a pre-heater before entering the microwave reaction chamber. Optionally, input gas is pre-heated to a temperature of no more than 1000° C., optionally no more than 900° C., optionally in the range of 200-900° C., optionally in the range of 400-600° C., most preferably about 500° C.

Preferably, gas in the microwave reaction chamber is below a plasma-forming temperature of the gas. Optionally, the temperature of gas within the microwave reaction temperature is below 900° C., optionally in the range of 200-900° C., optionally 400-600° C., optionally about 500° C. Gas temperature may be measured by an optical method such as Infrared Optical Pyrometer, e.g. in a headspace of the reactor.

Optionally, pressure of gas in the microwave reaction chamber is 0.1-10 atmospheres, preferably 0.5-3 atmospheres or 0.5-2 atmospheres.

Optionally, the microwave frequency is in the range of 0.5-20 GHz.

Optionally, the microwave power of the microwave source or sources (which is a combined microwave power in the case of multiple microwave sources) is at least 1 kW, optionally 1 kW-1 MW, optionally 1-100 kW. It will be understood that the microwave power required will depend in part on the size of the reactor.

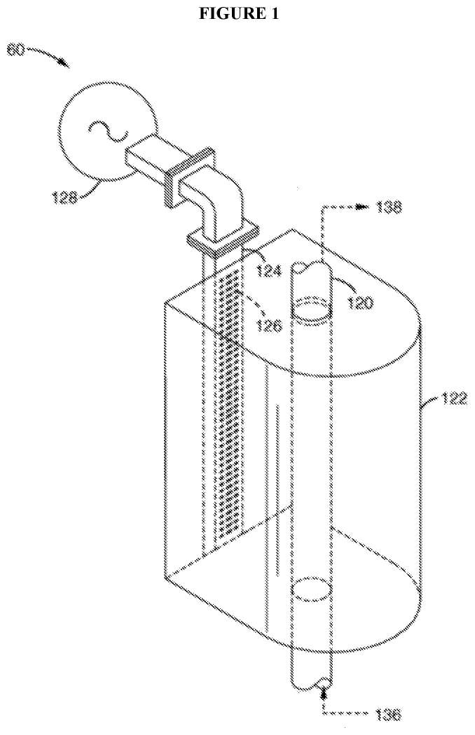

FIG. 1 is a schematic view of a microwave reactor 60. A tube 120, which is transparent to microwave energy, is positioned in microwave chamber 122.

A waveguide 124 having slots 126 is provided to direct microwave radiation into the chamber. In the embodiment of FIG. 1, the waveguide is attached to an external wall of the microwave chamber 126 however the skilled person will be aware of other configurations. In some embodiments, the waveguide 124 may pass through the microwave chamber; for example, the wave guide may be attached to an internal wall of the microwave chamber.

The internal walls of the microwave chamber are suitably selected for reflection of microwaves. The position of the waveguide relative to the internal walls may be selected for reflection of microwaves towards the tube 120.

The width and spacing of the slots may be optimized for the microwave wavelength used. A source of microwave energy 128 is configured to direct microwave energy into the waveguide 124

In one embodiment, tube 120 is quartz glass.

FIG. 1 illustrates a microwave reactor in which the carbon and/or metal or metal compound, optional microwave absorbing material and input gas within the microwave reaction chamber are contained within a tube which is transparent to microwave energy, however other embodiments will be apparent to the skilled person.

The microwave reaction chamber of FIG. 1 has a half-oval cross-section however it will be understood that any suitable shape, e.g. a rectangle, may be used.

FIG. 1 illustrates a microwave reactor having a single waveguide directing radiation into the microwave reaction chamber. In other embodiments, a plurality of such waveguides is provided.

In the embodiment of FIG. 1 input gas passes through the microwave chamber 122 in tube 120 containing the carbon and/or metal or metal compound and, if present, the microwave absorption material. The input gas may enter from inlet 136 and flow through the tube where it comes into contact with the carbon and/or metal or metal compound and, if present, the microwave absorption material and exit the reaction chamber at outlet 138.

FIG. 1 illustrates an arrangement in which the tube 120 is substantially vertical. According to this embodiment, gas may flow upwards through the tube 120. In other arrangements, the tube 120 may be closer to the horizontal than the vertical.

The microwave reaction chamber may be insulated to prevent heat loss, e.g. due to an endothermic hydrocarbon cracking reaction.

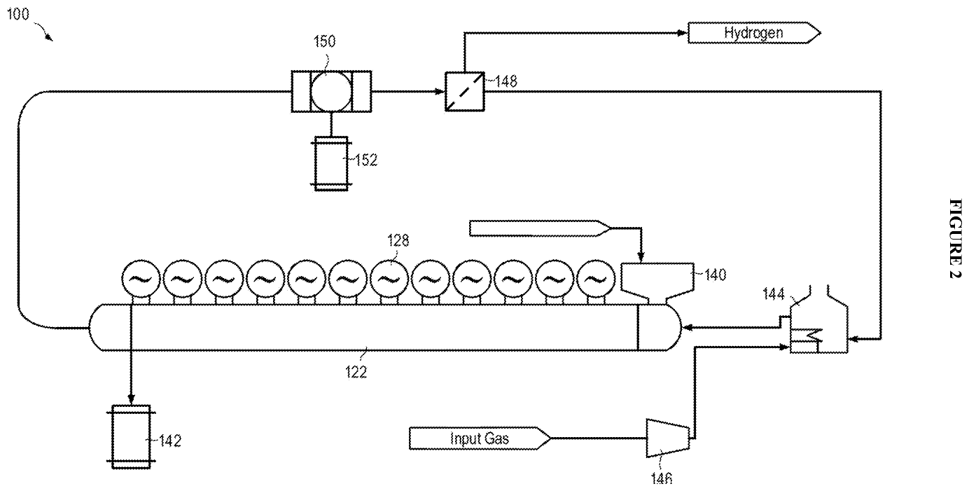

FIG. 2 illustrates apparatus 100 according to an embodiment of the present disclosure containing a microwave reaction chamber 122, for example as described with reference to FIG. 1. The microwave reaction chamber has a gas inlet and an gas outlet. The tube 120, as shown in FIG. 1, may extend between some or all of the distance between an inlet 136 and an outlet 138 of the microwave reaction chamber. The gas inlet and gas outlet may be opposing ends of the tube 120, as described with reference to FIG. 1.

The apparatus may comprise a feed hopper for introduction of metal or metal compound into the microwave reaction chamber and, optionally, a microwave-absorbing material, for example carbon black or silicon carbide. The feed hopper may be connected to a solid inlet of the tube 120.

The microwave reaction chamber may contain a moving bed.

Any moving bed arrangement known to the skilled person may be used. In some embodiments, the microwave reaction chamber 122 of apparatus such as illustrated in FIG. 2 may contain a screw, forming a pipe and screw arrangement to move the solid contents in the microwave reaction chamber 122 through the microwave chamber. In some embodiments, the moving bed may be a vibrating bed.

Solid product exiting the microwave reaction chamber may be collected in a collector 142. The tube 120 may contain a solid outlet for removal of solid product exiting the microwave chamber. The solid product may be collected in a collector. The carbon product may be separated using any method known to the skilled person.

Suitably, no components of the reaction bed are separated from one another within the microwave chamber.

In some embodiments, the moving bed may be inclined relative to the horizontal, for example as illustrated in FIG. 3. The moving bed allows for continuous or batch reactions to be carried out.

FIGS. 2 and 3 illustrate apparatus having a plurality of microwave energy sources 128. It will be appreciated that the number of microwave energy sources may be selected according to the desired dimensions and operating conditions of the apparatus.

An input gas, e.g. natural gas, may be heated by a pre-heater before entering the microwave reaction chamber. The pressure of gas in the apparatus may be set to any desired pressure, which may be above or below 1 atmosphere, for example by use of a gas compressor 146.

In some embodiments, for example as illustrated in FIG. 2, a feedstock gas and an input gas are the same, i.e. the feedstock gas is delivered to a microwave reaction chamber without any treatment to change its composition.

In some embodiments, a feedstock gas is treated to change its composition to an input gas composition, for example to remove oxygen-containing gases, particularly water.

Hydrogen contained in product gas exiting the microwave reaction chamber may be separated by a hydrogen separator 148 into hydrogen gas, and any unreacted input gas which may be recycled back to the microwave reaction chamber.

In the embodiment of FIG. 1, product gas separated from hydrogen is recycled to the microwave chamber.

In some other embodiments, not shown, for example where a metal oxide produces carbon monoxide and carbon dioxide, carbon monoxide may be separated from the product gas by a carbon monoxide separator. Remaining product gas may be recycled to the microwave reactor and carbon monoxide may be delivered to the fuel for the preheater 144 for combustion to provide heating of the preheater.

Fine particles entrained within the product gas, e.g. fine carbon black, may be separated using a particle filter 150 and collected in a particle collector 152.

It will be understood by the skilled person that the components of the apparatus of FIGS. 2 and 3 may be arranged in any suitable order.

The moving bed reactor may enable continuous production of carbon product, which may be removed from an outlet of the reaction chamber. The removed carbon product may or may not be separated from the metal or metal compound. Unseparated carbon product may be subsequently separated by any method known to the skilled person. A portion of the separated or unseparated carbon product may be recycled back into the reactor.

In other embodiments, the microwave reaction chamber may have a fluidised bed or fixed bed.

Hydrogen and carbon produced by a process as described herein may be used in a wide variety of applications known to the skilled person. Applications for hydrogen include, without limitation, as a fuel for an internal combustion engine or a hydrogen fuel cell. Applications for carbon black include, without limitation, in rubber, in dyes or as a component of a lithium-ion battery anode.

A reactor as described herein may be installed in a location where hydrogen fuel is required, for example a filling station for vehicles. Optionally, hydrogen produced according to a process described herein may be transferred directly to a storage tank on the same site.

### Examples

Methane cracking as described in these examples was performed using either single or double quartz tubes in a reactor described with reference to FIG. 1 with a microwave source producing 2.45 GHz microwaves.

1.5 cm Microwave Fixed Bed Testing—CTC-70, CTC-80 and MgO impregnated GAC

A 1.5 cm quartz tube was placed inside a 7.6 cm quartz tube.

The 1.5 cm quartz tube reactor was charged with 50 g CTC-70 granular activated carbon (GAC).

A 6 kW microwave generator was started microwave power was set to 2 kW.

N₂ was introduced at 2 standard cubic feet per hour (scfh). 0.5 scfh CH₄ was introduced into the 1.5 cm reactor.

Microwave power was adjusted to a level that provided CH₄ conversion greater than 80%.

The concentration of H₂, CH₄, CO, and CO₂ in the outlet gas was measured using the Wuhan Cubic coal gas analyzer every 10 minutes.

The CH₄ conversion rate was calculated every 10 minutes.

The above process was repeated using CTC-80 and MgO-impregnated activated carbon.

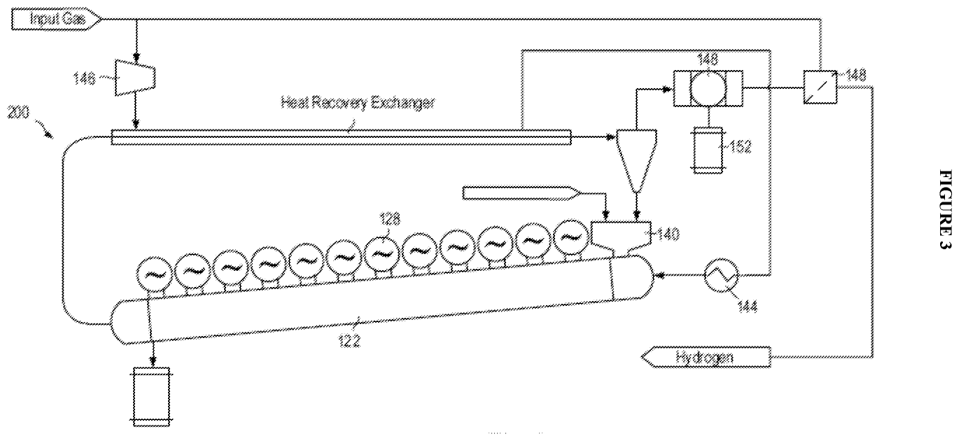

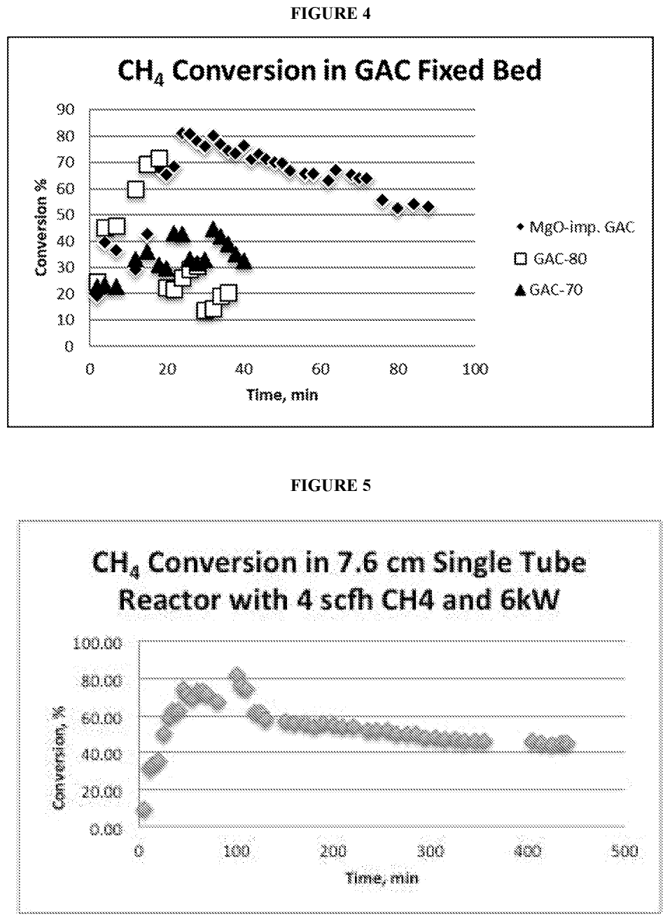

FIG. 4 presents CH₄ conversion as a function of time. The CH₄ conversion rate for MgO-impregnated GAC increased to 80% but decreased continuously after 30 minutes of testing. The conversions with CTC-70 GAC and CTC-80 GAC were much lower than 80%.

### 7.6 cm Microwave Fixed Bed Testing—Petroleum Coke

A single 7.6 cm quartz tube reactor was filled with 867 g of 0.7 mm spherical petroleum coke and tested. The bed height was 32 cm.

FIG. 5 shows that the CH₄ conversion increased to 80% at 100 minutes but decreased continuously thereafter

The carbon black generated from cracking in the above experiments was deposited at the surface of the activated carbon and could not be separated from the activated carbon. Without wishing to be bound by any theory, the decrease in the active surface is believed to be the main reason for the decrease in the conversion as reaction time increased, indicating that activated carbon alone is unsuitable for maintaining a high conversion of input gas.

Cracking with Iron Oxide Powder

Cracking was performed according to the following process:
1. A 9 cm reactor was charged with Fe₂O₃ powder (2 inches) between a lower, 4 inch layer of silicon carbide (SiC) and a 2 inch top layer of SiC.
2. The microwave generator was started. Power was set to 3 kW, which was increased to 3.5 kW.
3. Natural gas was introduced at 0.5 scfh and then increased to 1 scfh.
4. Concentrations of H₂, CH₄, CO, and CO₂ of the product gas were measured.
5. Testing was continued for 2 days.
6. The conversion rate was calculated every 10 minutes.

Because the Fe₂O₃ used was a fine powder, the CH₄ flow rate started at 0.5 scfh and gradually increased to 1 scfh in the first day of testing.

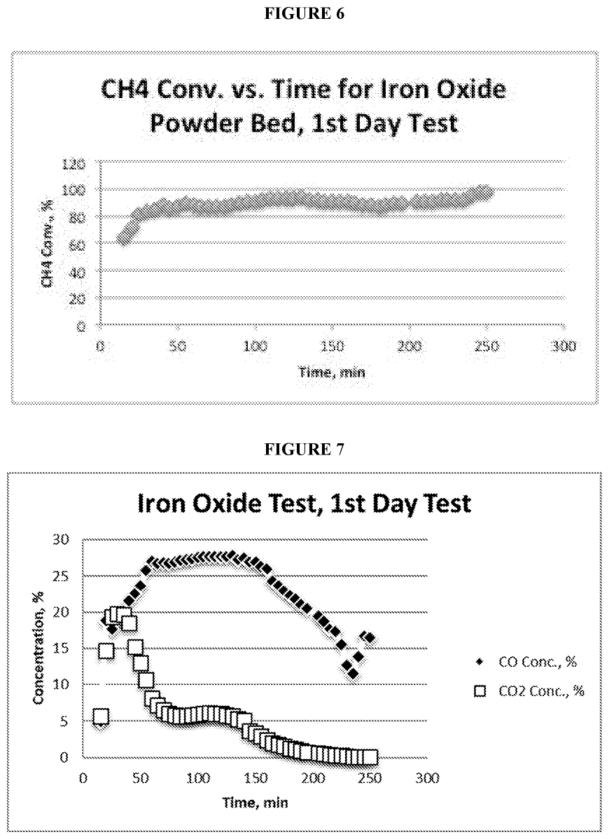

FIG. 6 shows the CH₄ conversion rate as a function of time for the first day of testing. As shown in this figure, the CH₄ conversion increased to 98% at the end of the first test day.

FIG. 7 shows the CO and CO₂ concentrations in the product gas as a function of time for the first day test. Since iron oxide is the only source of oxygen, it is apparent that the iron oxide is consumed to form CO and CO₂. The concentrations of CO₂ and CO decreased continuously after 150 minutes.

The iron oxide powder test continued for the second day to obtain the CH₄ conversion at various microwave powers and CH₄ flow rates. Table 1 presents test results from the second day iron oxide powder test.

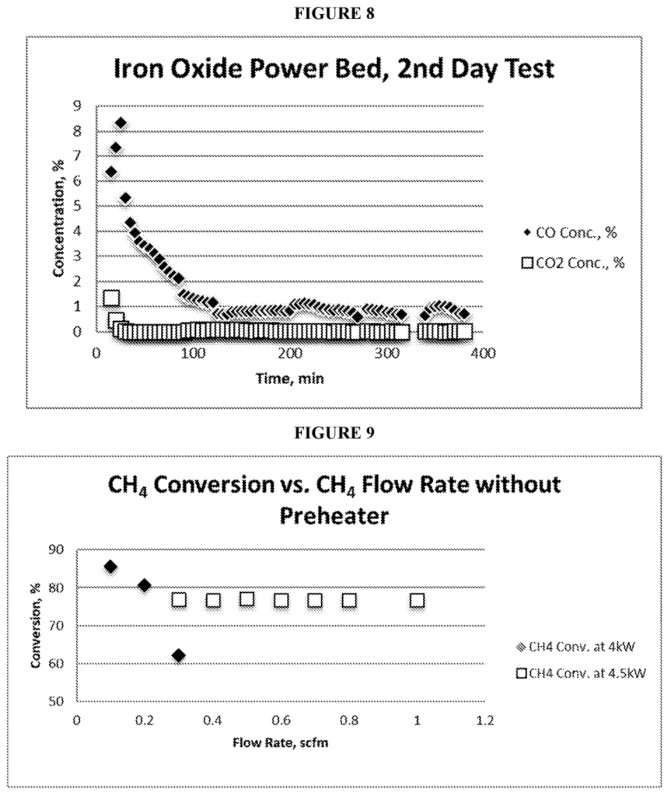

FIG. 8 presents the CO and CO₂ concentrations of the product gas for the second day Fe₂O₃ powder test. The concentrations continue to fall on day 2.

Without wishing to be bound by any theory, the fall in CO₂ and CO concentrations across days 1 and 2 is due to a decreasing amount of iron oxide.

Without wishing to be bound by any theory, the maintenance of a high conversion rate on day 1 after CO and CO₂ levels begin to fall may be due to catalysis by elemental iron formed from the iron oxide; catalysis by a Fe—C complex formed from the iron oxide; and/or catalysis by residual iron oxide itself.

As shown in Table 1, CH₄ conversion increased as the microwave power increased but decreased as the CH₄ flow rate increased.

TABLE 1

| | | | | | | | | | |
|---|---|---|---|---|---|---|---|---|---|
| MW Power, kW | [symbol] | [symbol] | 3 | 3.25 | 3.25 | [symbol] .25 | 3.25 | 3.5 | 4. [symbol] |
| CH4 Flow Rate, scfm | 0. [symbol] | 0. [symbol] | 1 | 1 | 1.1 | 1.2 | 1.3 | 1. [symbol] | 2 |
| CH4 Conversion, % | 85.74 | 81. [symbol] | 7 [symbol] . [symbol] | 80.4 [symbol] | 80.66 | 80.73 | 78.24 | 7 [symbol] .4 | 75.24 |
| Product Gas Composition | | | | | | | | | |
| H2, % | [symbol] .8 | 88.3 | 8 [symbol] .1 | 88.2 | 88.1 | 88.1 | 8 [symbol] .3 | 84.4 | 8 [symbol] . [symbol] |
| CH4, % | 7. [symbol] | 10.2 | 12.9 | 10.5 | 10. [symbol] | 10. [symbol] | 12.7 | 14.7 | 13.4 |
| CO, % | [symbol] .6 | 1.4 | 1.0 | 1.3 | 1.3 | 1. [symbol] | 1.0 | 0.8 | 1.1 |
| CO2, % | 0. [symbol] | 0.1 | 0.0 | 0.0 | 0.0 | 0.1 | 0.1 | 0.1 | 0.0 |

[symbol]

indicates data missing or illegible when filed

As shown in FIG. 8, the CO₂ concentration was very small, indicating that there was little or no formation of CO₂ from Fe₂O₃. The CO concentration was also very small and the decreased with time. This indicates that the CH₄ cracking was the primary reaction for Fe₂O₃ with CH₄.

The conversion varied between 71% and 86%.

### Iron Oxide-Impregnated Alumina: Effect of CH₄ Flow Rate on Conversion in Fixed Bed

Methane was cracked according to the following process:
1 A 9 cm reactor was charged with 1,500 mL (1,812 g) Fe₂O₃-impregnated alumina (5.1 mm) and 700 mL (876.7 g) SiC.
2 The microwave generator was set to 4 kW and increased to 4.5 kW.
3 Natural gas was introduced at 0.1 standard cubic feet per minute (scfm) and increased to 1 scfm.
4 Concentrations of H₂, CH₄, CO, and CO₂ of the product gas were measured.

Testing was performed over 2 days with the conversion rate calculated every 10 minutes.

The test started with a 0.1-scfm CH₄ flow rate and 4 kW of microwave power. The CH₄ conversion was measured for about 30 minutes and then the flow rate was increased. A 0.3 scfm flow rate provided a conversion rate of 62%.

FIG. 9 presents the conversion for flow rates from 0.1 to 1.0 scfm.

The conversion rate decreased as the flow rate increased with 4 kW of microwave power.

When the power was increased to 4.5 kW, the conversion remained at 77% until the flow rate reached 1.0 scfm. This indicated that the reaction bed could handle a higher gas flow rate and the heat loss should be reduced to maintain high conversion.

### Effect of Inlet Gas Temperature on Conversion

1. A 9 cm reactor was charged with 1,500 mL (1,812 g) Fe₂O₃-impregnated alumina (5.1 mm) and 700 mL (876.7 g) SiC.
2. The microwave generator was set to 4.5 kW.
3. CH₄ was introduced at 1 scfm and decreased to 0.7 scfm (8.1 cm/s linear velocity).
4. The inlet gas temperature was increased from 700 to 1,000° F.
5. Concentrations of H₂, CH₄, CO, and CO₂ of the product gas were measured.
6. The conversion rate every 10 minutes was calculated.

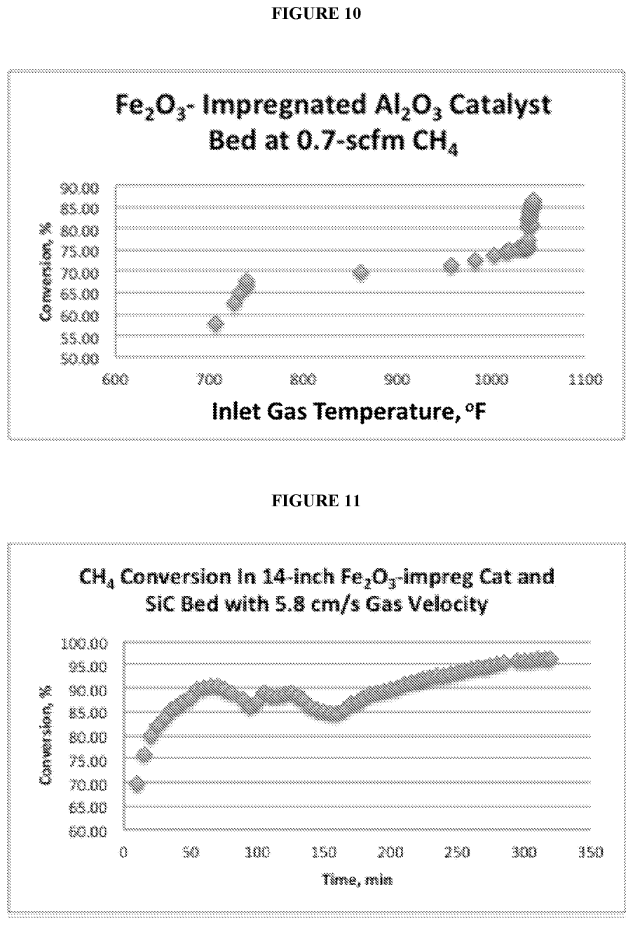

FIG. 10 shows the CH₄ conversion at various inlet gas temperatures.

The CH₄ conversion rate increased from 58% to 87% when the inlet gas temperature was increased from 700° F. (371° C.) to 1,044° F. (562° C.).

Fe₂O₃-Impregnated Alumina-SiC Fixed Bed Testing at 0.7 scfm N₂ and 5 scfh CH₄

The process described above for determining effect of the inlet gas temperature, but at a fixed temperature of 1000° F., was carried out over a period of more than 300 hours at 0.7 scfm N₂ and 5 scfh CH₄.

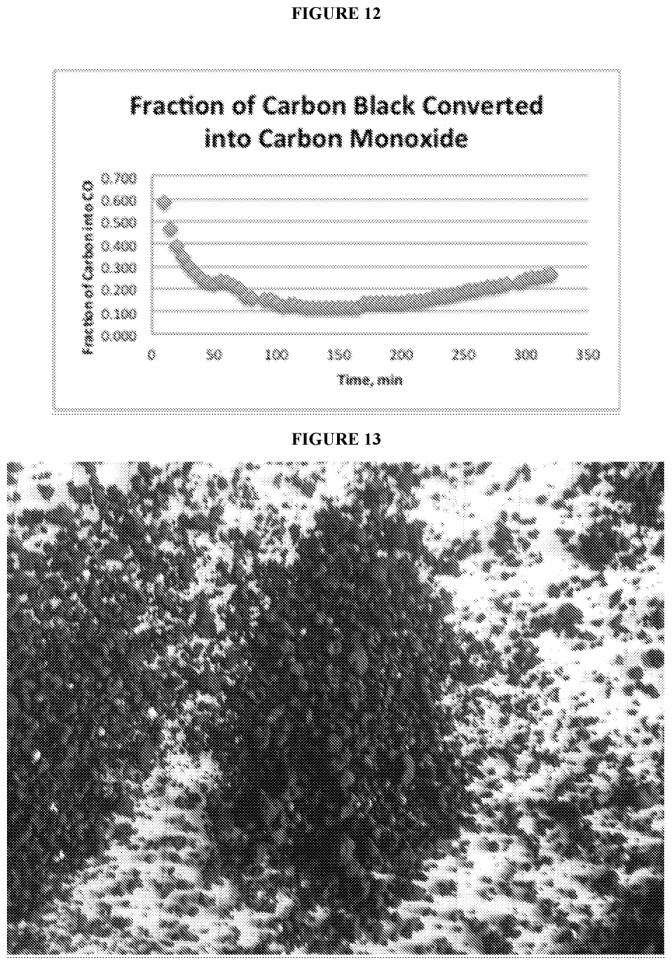

FIG. 11 and FIG. 12 respectively show the CH₄ conversion and fraction of carbon reacted with Fe₂O₃ as a function of time.

The CH₄ conversion increased continuously with time and reached over 96% after 300 minutes. The fraction of carbon black reacted with Fe₂O₃, determined from CO and CO₂ concentrations, decreased with time as shown in FIG. 12. The reaction of Fe₂O₃ with carbon formed Fe—C complex that catalyzed the CH₄ cracking reaction. This Fe—C complex remained with carbon product and increased the CH₄ conversion rate. Also, the carbon black formed the agglomeration with carbon product produced from CH₄ cracking that prevent the carbon product to coat the cracking reaction site. This suggests that the carbon product containing Fe—C complex needs to be present in the alumina or SiC bed to keep CH₄ conversion rate high.

The carbon black produced in the Fe₂O₃—SiC fixed bed was not separated from the bed by gas and stayed in the bed. The bed height was increased by 3 inches after 300 minutes confirming that carbon black produced from cracking stayed inside the bed. Since the Fe₂O₃ reacts with carbon produced from CH₄ cracking, it has to be replaced when it has been completely consumed.

Fe₂O₃-Impregnated Alumina Fixed Bed Without SiC

Cracking was performed according to the following process:
1. The 9 cm reactor was charged with 1000 mL Fe₂O₃-impregnated alumina.
2. Microwave power was set to 2.5 kW.
3. CH₄ was introduced at 5 scfh.
4. The inlet gas temperature was increased from 700 to 1,000° F.
5. Concentrations of H₂, CH₄, CO, and CO₂ of the product gas were measured.
6. The conversion rate was calculated every 10 minutes.
7. Steps (3) to (6) were repeated using natural gas instead of bottled CH₄. The natural gas contained about 10% of C2 and higher hydrocarbons as well as about 4 ppm sulfur compound.

The Fe₂O₃-impregnated alumina was separated and tested without mixing SiC. The bed provided a very high conversion rate for both bottled CH₄ and natural gas, mainly due to long residence time of CH₄. But the bed pressure drop was greater than 5 pisg at 5 scfh gas flow rate, as shown in Table 2.

TABLE 2
Test Result from Fe₂O₃ Bed without SiC

| Test Day | First | Second | Third |
|---|---|---|---|
| Run Time (min) | 400 | 350 | 420 |
| CH₄ Flow (scfh) | 5 | 4.2 | 2.5 |
| MW Power (kW) | 2.5 | 2.5 | 2.5 |
| Gas | Methane | Methane | Natural Gas |
| CH₄ Conversion (%) | 98.5 | 98.2 | 97.8 |

The microwave energy was not distributed evenly, and a hotspot developed at the top of the bed that melted the Fe₂O₃. When the Fe₂O₃ was mixed with SiC, the microwave distribution was more uniform, and no hot spots developed. The carbon black produced after three days of testing was estimated at 1,105 g but only 322 g of carbon black was recovered with the Fe₂O₃. The outlet gas carried out 721 g of carbon black, suggesting that carbon black could be separated from the Fe₂O₃ if a higher gas velocity is used. Without wishing to be bound by any theory, the high proportion of fine carbon black entrained in the outlet gas may be due to the absence of carbon black at the start of the reaction to provide a nucleation point for carbon black generated during the reaction.

The average product gas composition was 95.44% H₂, 0.94% CH₄, 3.55% CO, and 0.06% CO₂. The amount of carbon reacted with Fe₂O₃ to produce CO was estimated at 62 g, 5.6% carbon produced. This indicated that the microwave cracking with iron oxide could reduce CO₂ emission by 94.6% compared with steam reforming.

A microwave reactor was filled with 2,400 mL of Fe₂O₃ impregnated alumina without SiC. The test started at 1 scfm N₂ and 2 scfh natural gas at 2 kW. The microwave power increased slowly to 4 kW. The carbon black was separated from the bed at the top and the bed height was increased continuously. However, the conversion rate decreased as the carbon black was removed from the bed, indicating the need to retain carbon black in the bed to maintain a high conversion rate. As described earlier, the reaction of Fe₂O₃ with carbon black formed Fe—C complex that remained inside carbon black and catalyzed the CH₄ cracking reaction. However, the carbon black formed an agglomeration at the top of the bed but could not be carried out by the outlet gas. FIG. 13 shows the picture of agglomerated carbon black accumulated at the top of the bed.

### Fixed Bed Using Carbon Black Formed by Cracking

The carbon black removed from Fe₂O₃-impregnated alumina bed as described above is believed to contain a Fe—C complex and Fe₂O₃. This carbon black was used in a cracking reaction as follows:
1. The 9 cm reactor was charged with 2,700 mL (1,383.7 g) of carbon black produced from the above Fe₂O₃-impregnated alumina bed tests.
2. Microwave power was set at 2 kW and increased to 3 kW.
3. Natural gas was introduced at 1 scfh and slowly increased until the carbon black bed was lifted up.
4. Concentrations of H₂, CH₄, CO, and CO₂ of the product gas were measured.
5. The conversion rate every 10 minutes was calculated.
6. 2 inches of SiC was added to the top of the carbon black bed to prevent the bed lifting.
7. Steps (2) through (7) were repeated using 2 scfh natural flow rate in Step (3).

Natural gas flow was increased from 1 scfh to 2.4 scfh. At 2.4 scfh NG the carbon black bed was lifted and the test was discontinued.

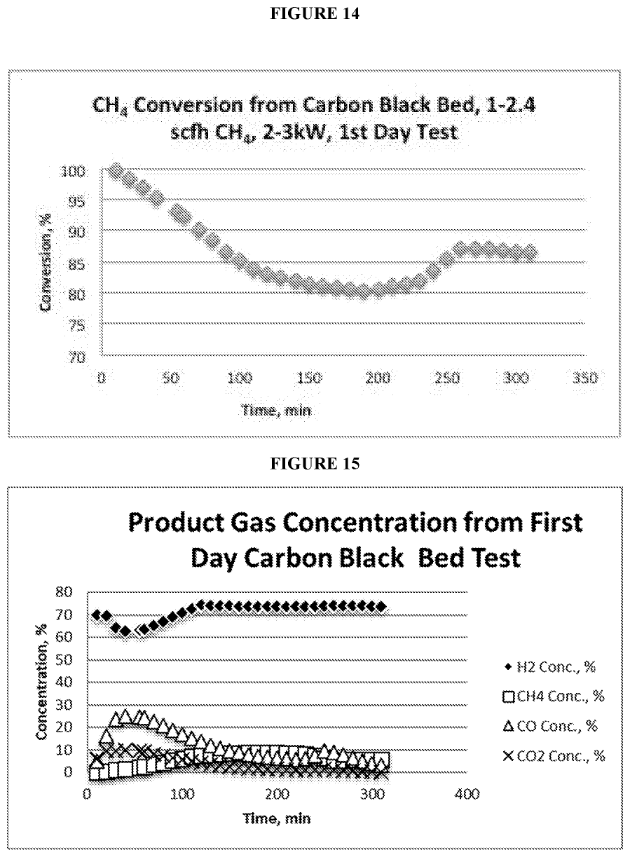

FIG. 14 and FIG. 15 respectively present the conversion rate and product gas composition as a function of time. The conversion rate started very high with 1 scfh but decreased to 80% as the flow rate increased. When the power increased to 3 kW, the conversion rate increased to 87%. High CO and CO₂ concentration clearly indicated that the carbon black contained iron oxide.

The natural gas conversion rate was greater than 80% as shown in FIG. 14. The carbon black used in this experiment might contain some iron oxide produced from the Fe₂O₃ impregnated alumina tests. Also, the carbon black contained a Fe-carbon complex that forms upon consumption of iron oxide and that catalyzes natural gas cracking.

The test was continued to a second day. The conversion rate started at 78% and decreased to 72% after 50 minutes. The conversion rate stayed at 72% for 200 minutes and then decreased to 70%. The CO and CO₂ concentrations started respectively at 3% and 2% and decreased to 2% and 0% after 200 minutes. This indicated that the carbon black contained Fe₂O₃ and Fe—C complex and that the Fe—C complex was the catalyst for microwave cracking. This test indicated that the carbon black produced from NG cracking could be used for microwave cracking.

Carbon Black-SiC Coated with Fe₂O₃

The main objective of this test was to investigate the reaction of Fe₂O₃ with carbon black product to form Fe—C complex and determine if the conversion efficiency increased.
1. SiC coated with Fe₂O₃ powder was prepared by mixing SiC particles with Fe₂O₃ powder.
2. The 9 cm reactor was filed with 8 layers of 150 mL SiC followed by 300 mL carbon black. Total amounts of Fe₂O₃ coated SiC and carbon black were 1,200 mL (1,629 g) and 2,400 mL (1,202 g), respectively.
3. Microwave power was started at 2 kW and increased to 4 kW.
4. Natural gas was introduced at 2 scfh.
5. Concentrations of H₂, CH₄, CO, and CO₂ of the product gas were measured.
6. The conversion rate every 10 minutes was calculated.
7. The test was conducted for two days.

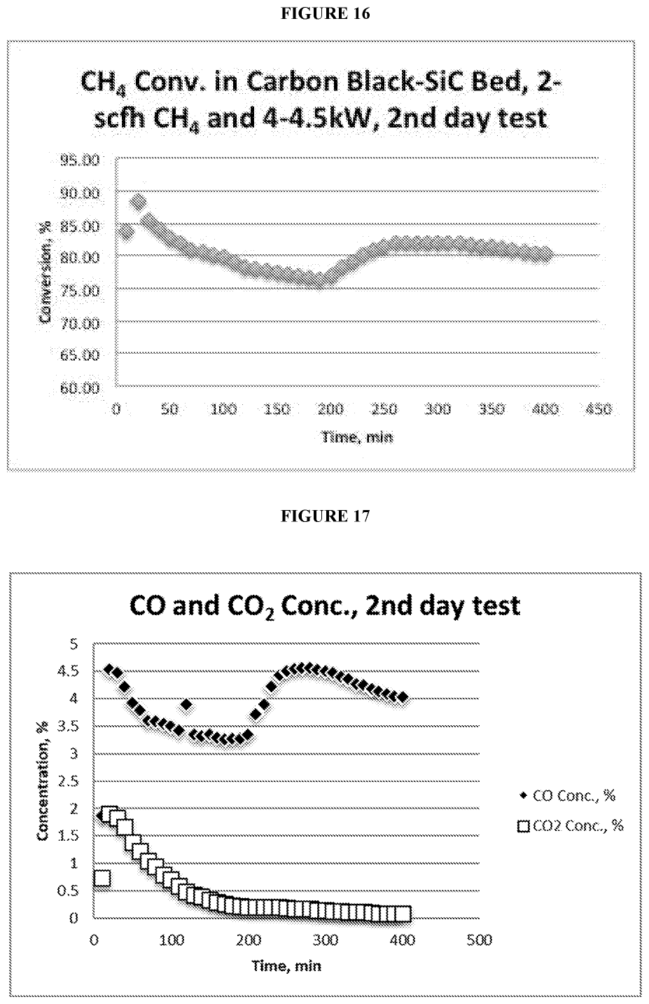

Results are presented in FIG. 16 through FIG. 18. The CH₄ conversion rate increased with time to more than 85% in the first day but decreased to 80% in the second day. The CO and CO₂ concentrations started greater than 15% but decreased to below 5% in the first day. The CO concentration in the second day started below 5% and decreased to 4%. The CO₂ concentration started about 2% and decreased to below 0.5%.

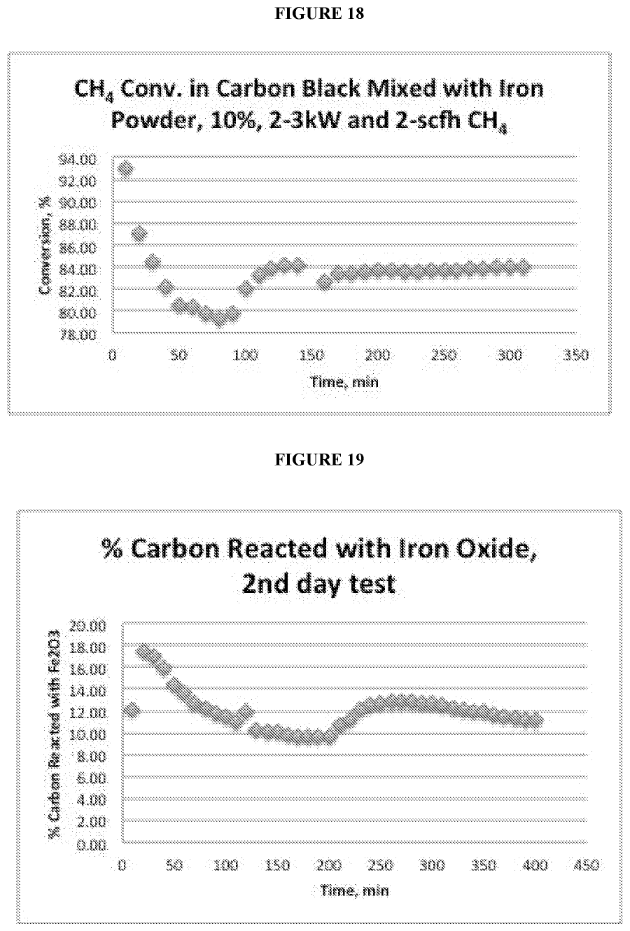

FIG. 18 presents the percent carbon black reacted calculated from CO and CO₂ concentration data. The amount of carbon black that reacted with iron oxide decreased continuously, suggesting that the Fe—C complex catalyzed the microwave CH₄ cracking. If the Fe—C complex generated from the reaction of Fe₂O₃ with carbon black stays at the SiC surface, carbon black can be separated from the SiC fixed bed by using a higher gas velocity.

### Carbon Black-Iron Powder Test

Methane cracking using carbon black and iron powder was performed according to the following procedure:
1. The 9 cm reactor was charged with 1,000 g carbon black mixed with 100 g iron powder (10 wt % iron powder).
2. 200 g SiC mixed with 5 g iron powder was added at the top of the carbon black bed to prevent it lifting.
3. Microwave power started at 2 kW and increased to 3 kW.
4. Natural gas was introduced at 2 scfh.
5. Concentrations of H₂, CH₄, CO, and CO₂ in the product gas were measured.
6. The conversion rate every 10 minutes was calculated.

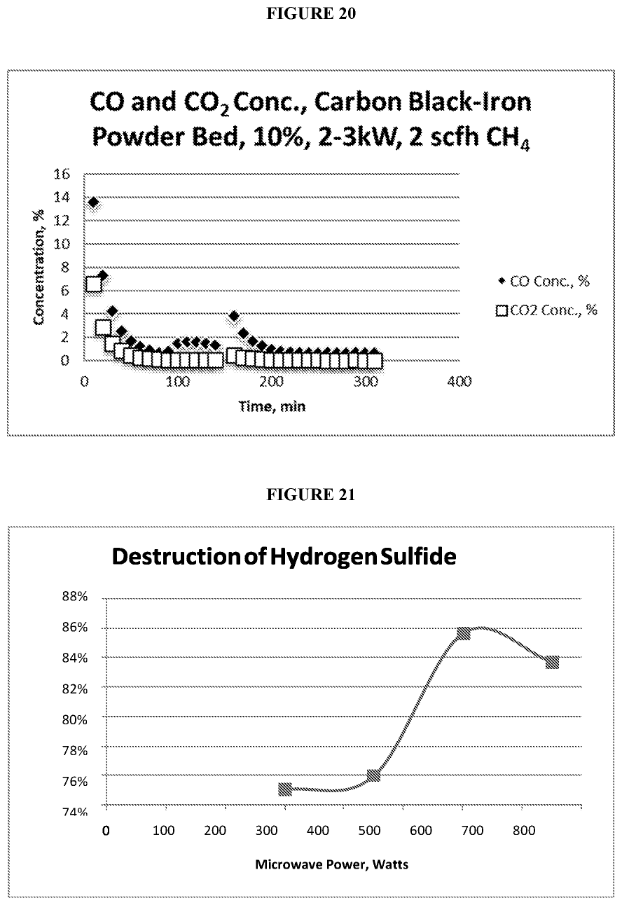

FIG. 19 through FIG. 21 present the results from this test. The CH₄ conversion rate started greater than 92% but decreased continuously. When the conversion rate decreased to 80%, the microwave power was increased to 3 kW. The conversion rate then increased to 84% until the test was completed. The CO concentration started at 14% but decreased below 2% after 50 minutes. Also, the CO₂ concentration started at 6% but decreased to below 1% after 50 minutes. As shown in FIG. 21, about 50% of carbon produced from cracking reacted with Fe₂O₃ but after 50 minutes less than 10% of the carbon reacted. After 200 minutes of testing, less than 2% of carbon reacted with Fe₂O₃, indicating that the iron powder could catalyze microwave cracking without reacting with carbon black.

The NG conversion in the carbon black-iron powder bed is greater than the carbon black alone. The iron powder is an excellent microwave absorbent that could increase natural gas conversion.

### H₂S Measurement

Methane cracking using carbon black and iron powder was performed according to the following procedure to assess destruction of H₂S:
1. The 1.5 cm quartz tube reactor was filled with activated carbon CTC-70.
2. N₂ was introduced into the reactor at 18 scfh.
3. H₂S was injected into the inlet N₂ at 10 cc/min (1000 ppm H₂S in N₂).
4. The concentration of H₂S in inlet and outlet gas streams was measured.
5. Microwave power was set to 300 W.
6. H₂S destruction efficiency as a function of microwave power was measured.

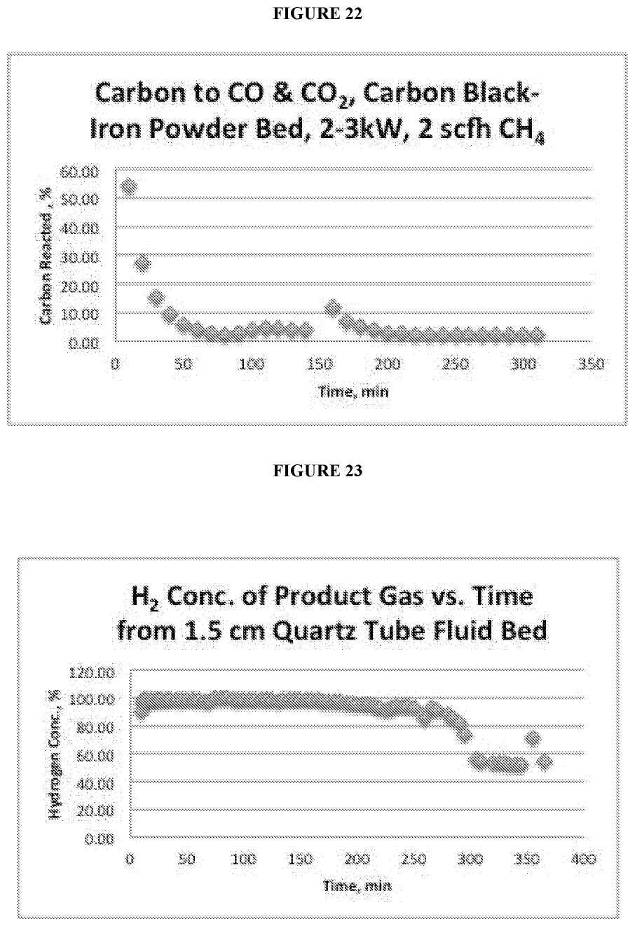

FIG. 22 shows that the H₂S dissociation efficiency increased to 86% as the microwave power increased to 600 W and then reached equilibrium at the microwave input power of 700 W. Natural gas contains about 4 ppm sulfur compounds. The sulfur compound concentration in natural gas is preferably below 1 ppm to prevent catalyst poisoning. Microwave power higher than 600 W is shown to decompose H₂S of natural gas to below this level. The temperature of carbon black leaving the reactor will typically be lower than the sulfur boiling temperature of 445° C.

### 1.5 cm Fluidized Bed Microwave Reactor Test

1. A 1.5 cm quartz tube was placed inside a 7.6 cm quartz tube.
2. The 1.5 cm quartz tube reactor was charged with 50 g petroleum coke (0.6.1.3 mm).
3. Microwave power was set to 2 kW.
4. The petroleum coke was fluidized with 2 scfh N₂.
5. 0.3 scfh CH₄ was introduced into the 1.5 cm reactor. The linear velocity of inlet gas was 10.3 cm/s.
6. The microwave power was adjusted to a level for CH₄ conversion rate greater than 80%.
7. The concentration of H₂, CH₄, CO, and CO₂ in the outlet gas using the Wuhan Cubic coal gas analyzer was measured every 10 minutes.
8. The CH₄ conversion rate every 10 minutes was calculated.

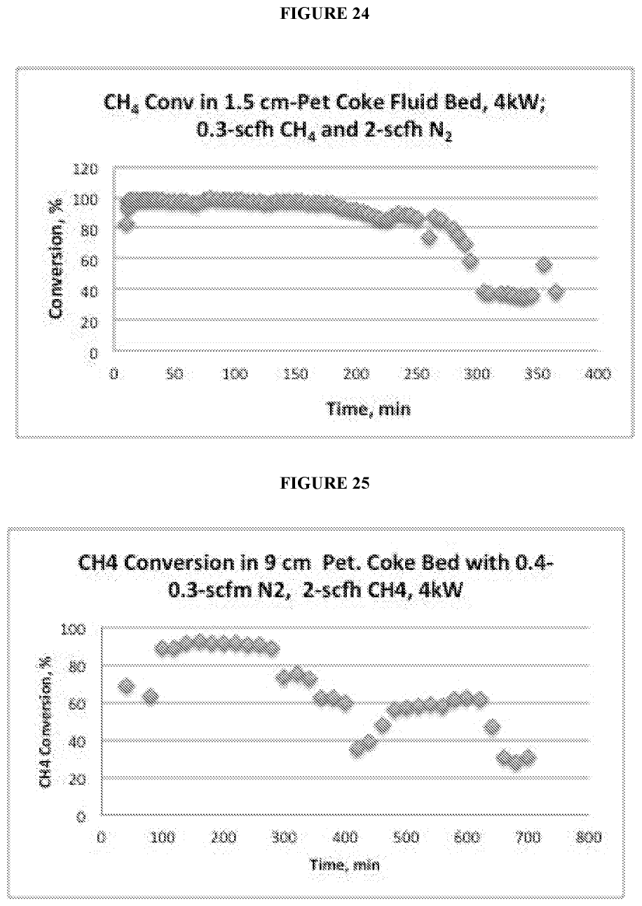

FIG. 23 and FIG. 24 present the CH₄ conversion and hydrogen concentration of product gas as a function of time, respectively.

The CH₄ conversion rate was higher than 95% with 4 kW microwave power for 200 minutes but decreased continuously to 50% at 300 minutes. The carbon black generated from CH₄ cracking covered the petroleum coke surface, which decreased the particles' cracking activity. The bulk density of petroleum coke increased from 0.60 to 0.74 g/mL, confirming that carbon black accumulated at the petroleum coke surface and decreased the active surface area. The amount of carbon black generated was estimated at 22.59 g and the weight gain of petroleum coke was 7.7 g. This result indicates that 34% of the carbon black remained at the petroleum carbon surface. Because the carbon black accumulated at the coke surface, it caused a decrease in the active surface area for CH₄ cracking.

The H₂ concentration shown in FIG. 24 showed the same trend as the CH₄ conversion in the activated carbon fixed bed (FIG. 23). No higher hydrocarbons were detected in the product gas, confirming that one mole of CH₄ generated two moles of H₂.

### 9 cm Fluidized Bed Microwave Reactor Test

A double quartz tube reactor having a 9 cm tube inside a 11.5 cm quartz tube was used. A small particle size petroleum coke GAC (0.5-1.3 mm) was used to investigate how carbon black could be separated from the carbon surface to prevent a decrease in the surface area of petroleum coke. Inlet gas was pre-heated to about 900° F.

The petroleum coke GAC was fluidized with a CH₄ flow rate of 0.1.0.3 scfm. The CH₄ conversion rate started at higher than 80% but decreased continuously after approximately one hour. The carbon bed microwave absorption monitoring showed that the bed did not absorb microwaves efficiently as test time increased. After several tests, it was concluded that the inlet CH₄ has to be pre-heated to about 1,000° F. to maintain high CH₄ conversion.

Fluid bed testing started by fluidizing 1,157 g (2,000 mL) petroleum coke with 0.4 scfm N₂ and 2 scfh CH₄. After 80 minutes, the N₂ flow rate was reduced to 0.3 scfm to increase the CH₄ conversion. As shown in FIG. 25, the CH₄ conversion rate increased from 64% to 89% when the N₂ flow rate was reduced to 0.3 scfm and the inlet gas temperature was increased to about 1,000° F. The test was continued in the second day using 0.3 scfm N₂ and 2 scfh CH₄. The CH₄ conversion rate was greater than 90% with petroleum coke that was fluidized with 0.3 scfm N₂. The test was continued for a third day with the same conditions as the second day. The CH₄ conversion rate started below 80% and decreased continuously to 40%. The results from the second and third days of testing are also included in FIG. 25.

To improve the microwave distribution, the test was continued using the 9 cm reactor with the same condition as the third day test. The CH₄ conversion started about 40% and increased to 60% and stayed above 60% for 120 minutes and then decreased continuously to 30%.

The bulk density of fresh petroleum coke was 0.572 g/mL. The bulk density of used petroleum coke was increased to 0.692 g/mL. This increase indicated that the carbon black produced from CH₄ cracking was deposited at the surface of petroleum coke. The decrease in the conversion after 300 minutes was attributed mainly to the decrease in the surface area of petroleum coke. The used petroleum coke was reactivated with steam and microwaves. The bulk density of the reactivated coke was decreased to 0.605 g/mL, close to fresh coke bulk density. This test confirmed that CH₄ cracking occurred at the surface of petroleum coke. However, re-activation of petroleum coke generates CO₂.

Carbon black could not be separated continuously from the petroleum coke.

### Iron Oxide-Impregnated Alumina Catalyst Fluidized Bed Testing

1.8 mm alumina particles were impregnated with iron oxide. The Fe₂O₃ content of this catalyst was 46.5 g Fe₂O₃/100 g Al₂O₃.

Testing of the fluidized bed was conducted with 30 scfh natural gas. The catalyst absorbed microwaves well and carbon black was separated from the catalyst and accumulated above the catalyst bed. However, the conversion of NG to H₂ and carbon black was very low. In addition, more than one half of the catalyst was lost when the outlet gas moved carbon black out from the reactor.

1. A process of forming hydrogen and a carbon product comprising passing a hydrocarbon-containing input gas through a reaction bed in a microwave reaction chamber and irradiating the microwave reaction chamber with microwave radiation wherein the reaction bed comprises a particulate material comprising at least one of a metal or metal compound and a carbon material.

2. The process according to claim 1 wherein the reaction bed comprises a particulate material comprising the metal or metal compound.

3. (canceled)

4. The process according to claim 1, wherein the reaction bed comprises the metal or metal compound and further comprises a microwave-absorbing compound.

5. A process of forming hydrogen and a carbon product comprising bringing a hydrocarbon-containing input gas into contact with a combination of microwave-absorbing material and a metal or metal compound in a microwave reaction chamber and irradiating the microwave reaction chamber with microwave radiation.

6. The process according to claim 5 wherein the hydrocarbon-containing input gas is passed through a reaction bed comprising the microwave-absorbing material and the metal or metal compound.

7. The process according to claim 1, wherein the carbon product is carbon black.

8. The process according to claim 1, wherein additional carbon is added to the reaction chamber.

9. (canceled)

10. The process according to claim 7 wherein a portion of solid product containing carbon product which has been removed from the microwave reaction chamber is recycled back to the reaction chamber.

11. The process according to claim 1, wherein the carbon product is not separated from the reaction bed in the microwave reaction chamber.

12. The process according to claim 7, wherein the residency of the carbon product in the reactor while the reaction is ongoing is selected according to a desired carbon product mean diameter.

13. (canceled)

14. The process according to claim 1, wherein the metal or metal compound is consumed during the process.

15. The process according to claim 1, wherein additional metal or metal compound is added to the reaction chamber.

16. The process according to claim 1, wherein the metal or metal compound is iron oxide.

17. (canceled)

18. (canceled)

19. The process according to claim 5, wherein at least 50 mol % of the hydrocarbon in the input gas is converted to hydrogen gas in a single pass reaction.

20. (canceled)

21. The process according to claim 1, wherein the metal or metal compound is a metal oxide and wherein carbon monoxide and carbon dioxide in a product gas produced in a single pass process collectively make up between 0.1-10 vol % of the product gas.

22. (canceled)

23. The process according to claim 1, wherein gas temperature in the microwave reaction chamber is below 1000° C.

24. The process according to claim 5, wherein the input gas is free from water.

25. Apparatus for conversion of a hydrocarbon to hydrogen and carbon black comprising:
a microwave radiation source; and
a microwave reaction chamber having a gas inlet for introduction of an input gas comprising a hydrocarbon; a gas outlet for removal of a product gas from the microwave reaction chamber; a solid inlet for introduction of solid material into the microwave reaction chamber; and a solid outlet for removal of solid product from the reaction chamber.

26. (canceled)

27. (canceled)

28. (canceled)

29. (canceled)

30. (canceled)

31. (canceled)

32. A composition comprising a particulate metal or metal compound and a particulate microwave-absorbing material which is different from the metal or metal compound.

33. (canceled)

34. (canceled)
